(19) United States
(12) Patent Application Publication
(10) Pub. No.: US 2024/0256766 A1
(43) Pub. Date: Aug. 1, 2024

(54) CONTENT MANAGEMENT TOOLS

(71) Applicant: Sony Interactive Entertainment LLC, San Mateo, CA (US)

(72) Inventors: Davina Mackey, Menifee, CA (US); Christian Davis, Trabuco, CA (US); Ritchard Markelz, Temecula, CA (US); Justin Anderson, San Diego, CA (US)

(21) Appl. No.: 18/101,793

(22) Filed: Jan. 26, 2023

(51) Int. Cl. G06F 40/186; G06F 3/0486

(52) U.S. Cl. CPC G06F 40/186; G06F 3/0486

(57) ABSTRACT

Bringing all aspects of credit gathering into a single application, including: receiving credit entries submitted by users and enabling the users to edit the credit entries confidentially with an end-to-end service and under a permissions structure, wherein the credit entries are received as templates, wherein the end-to-end service includes ordering and editing features; adding an open and lock titles feature to manage a timeline and structure of submitting and editing credits for a title; and setting up a notification engine to provide the users with visibility of changes and exclusions to the credit entries.

### BACKGROUND

### Field

The present disclosure relates to content management, and more specifically, to content management tools to bring all aspects of content gathering into a single location with metaverse.

### Background

Conventional content management process including credit management for video production (e.g., production of games, movies, music videos, TV shows, etc.) usually involves collecting credit information towards the end of a development cycle by merging numerous emails, spreadsheets, and documents, which may result in changes being lost or unaccounted for, communication and visibility being limited, and extra time and effort being spent during this crucial time in the development of the production.

### SUMMARY

The present disclosure provides for implementing credit management.

In one implementation, a method for bringing all aspects of credit gathering into a single application is disclosed. The method includes: receiving credit entries submitted by users and enabling the users to edit the credit entries confidentially with an end-to-end service and under a permissions structure, wherein the credit entries are received as templates, wherein the end-to-end service includes ordering and editing features; adding an open and lock titles feature to manage a timeline and structure of submitting and editing credits for a title; and setting up a notification engine to provide the users with visibility of changes and exclusions to the credit entries.

In another implementation, a credit management system to gather and manage credit submissions for a title in templates includes an interface, an end-to-end service, a templated credits unit, and an order and edit features unit. The interface receives the credit submissions from teams and departments. The end-to-end service to manage the received credit submissions in the templates, wherein the templates include multiple points of contact for each team, department, and title. The templated credits unit enables a user to add, remove, or update individuals within each team, and add descriptive categories to provide detailed information about teams and individuals. The order and edit features unit to provide an expanded view of all teams to view individual credits, wherein the order and edit features unit enables the user to edit names and roles and reorder individuals, teams, and departments using drag and drop features, and wherein the order and edit features unit also enables the user to exclude individuals who did not meet requirements of the title. The open and lock feature unit to open submissions for the teams to submit credits while a title is unlocked, and for studios to edit the credits while the title is locked.

In yet another particular implementation, method for tracking digital content and modifications to that content made by multiple users across metaverse is disclosed. The method includes assigning metadata to the digital content, wherein the metadata is used to track who created the digital content, and wherein the metadata includes a hash generated to identify the digital content and a cryptographic key used to sign the unique hash to validate the authenticity of the hash. The method also includes storing the metadata in datastore to hold the hash and the cryptographic key to track and verify the digital content and an ownership of the digital content.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1A is a flow diagram of a credit management process to bring all aspects of credit gathering into a single application in accordance with one implementation of the present disclosure;

FIG. 1B illustrates in detail the end-to-end service in accordance with one implementation of the present disclosure;

FIG. 1C illustrates in detail the templated credits in accordance with one implementation of the present disclosure;

FIG. 1D illustrates in detail the ordering and editing features in accordance with one implementation of the present disclosure;

FIG. 1E illustrates in detail the title open and lock feature in accordance with one implementation of the present disclosure;

FIG. 1F illustrates in detail the notification engine in accordance with one implementation of the present disclosure;

FIG. 1G illustrates in detail the communication channels in accordance with one implementation of the present disclosure;

FIG. 1H is sample in-game credits, which may be generated by the credit management process described above;

FIG. 2 is a block diagram of a credit management system to bring all aspects of credit gathering into a single application in accordance with one implementation of the present disclosure;

FIG. 3 is a flow diagram of a metaverse content management process to track user-generated digital content and all modifications to that content made by multiple users across the metaverse;

FIG. 4A is a representation of a computer system and a user in accordance with an implementation of the present disclosure; and

FIG. 4B is a functional block diagram illustrating the computer system hosting the credit management application in accordance with an implementation of the present disclosure.

### DETAILED DESCRIPTION

As described above, the conventional credit management process for video production usually involves collecting credit information towards the end of a development cycle by merging numerous emails, spreadsheets, and documents, which then go through many iterations and versions of editing across various departments and/or individuals. The process may also involve gathering communications in emails and chat messages, credits in a limited tool and across spreadsheets, and final credits visible only after the credits are imported into the game, movie, or video. Thus, this process may result in changes being lost or unaccounted for, communication and visibility being limited, and extra time and effort being spent during this crucial time in the development of the production.

To address the issues with the conventional content management process including credit management, certain implementations of the present disclosure provide for having a centralized source where all team credit information is held, title submissions are processed, changes are accounted for, communication channels are made available, and is visible and accessible to all departments and individuals.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, a credit management application is provided to bring all aspects of credit gathering into a single location. That is, all communication and versions are handled within the application so that there is no opportunity for changes to be lost within multiple versions of a spreadsheet (e.g., Google Doc or Excel Workbook). Any errors from reordering, editing, or spelling are fixed early on because the changes are made within the application, which is visible to all involved users. The credit management application also enables collaboration and visibility for everyone involved in the video production so that there is less room for errors and plenty of time to fix the errors in the early stages of the video production. The credit management application also provides the means to (1) gather end game credits across all departments, (2) order and format the credits to the needs of each department, and (3) deliver a final set of submissions all within a single location.

In one implementation, key features of the credit management application include: (1) an end-to-end service that handles the credit management process; (2) full web application with authentication and user management; (3) a notification engine to provide visibility of all changes and exclusions to teams and individuals; (4) a robust permissions structure for user submissions, studio edits, and confidentiality; (5) templated credits to enable quick submissions; (6) easy to use ordering and editing features for both user submissions and studio edits; (7) non-standard credits allowed; (8) efficient communication channels to keep all messaging centralized and tracked; (9) a variety of export formats; (10) open and lock titles feature to manage a timeline and structure of submitting and editing credits; and (11) a change request process for edits that are outside the credits timeline.

Metaverse is a virtual-reality space in which users can interact with a computer-generated environment and other users. In another implementation, the concept of the credit management is extended or broadened to track user-generated digital content and all modifications to that content made by multiple users across the metaverse.

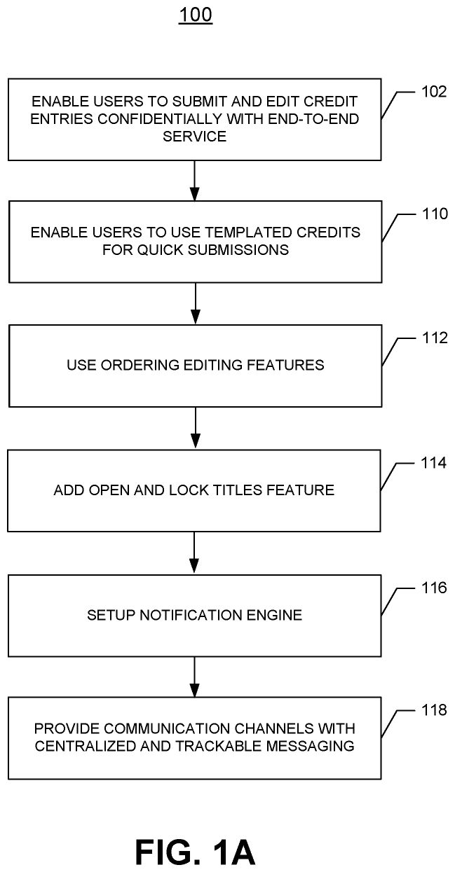

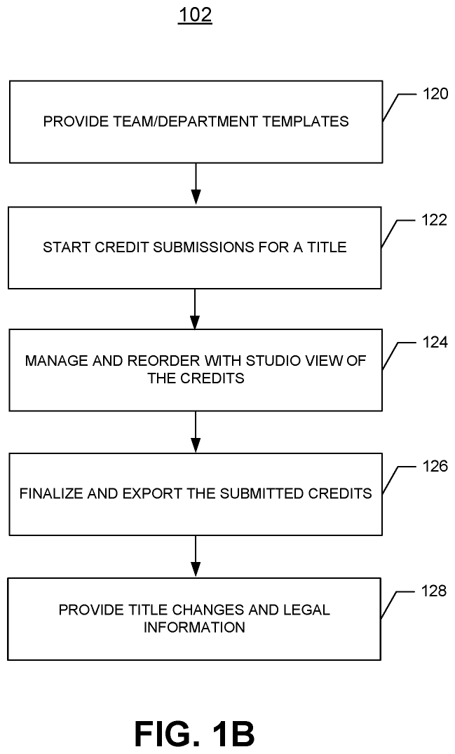

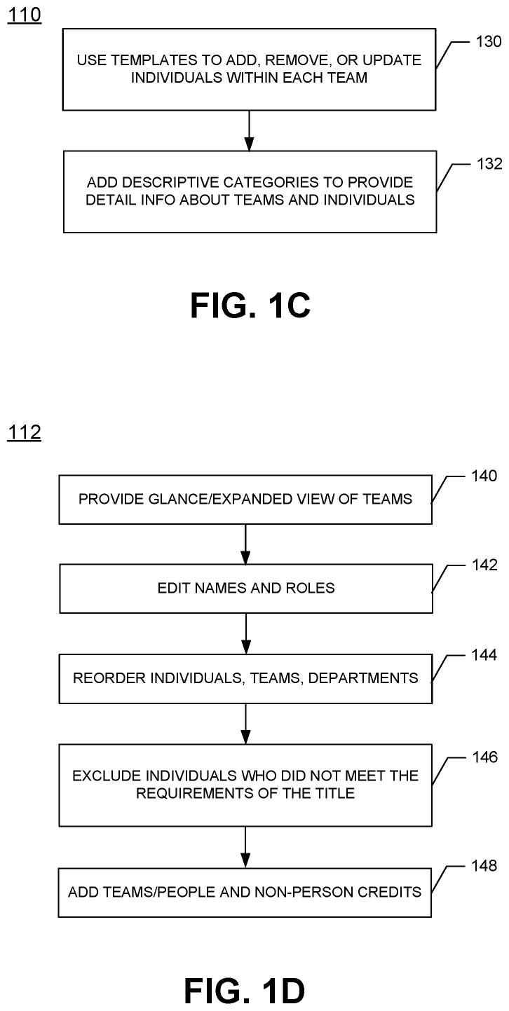

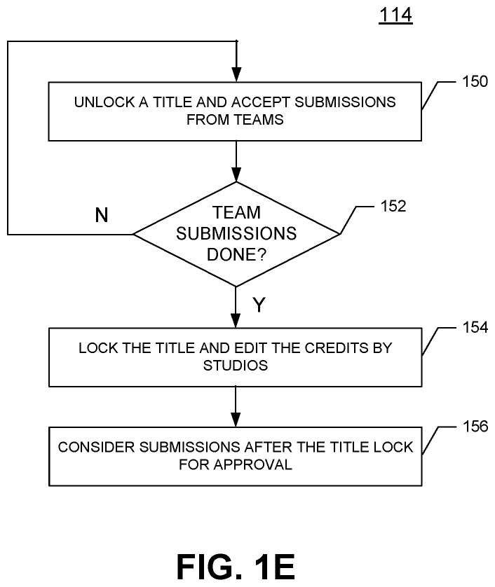

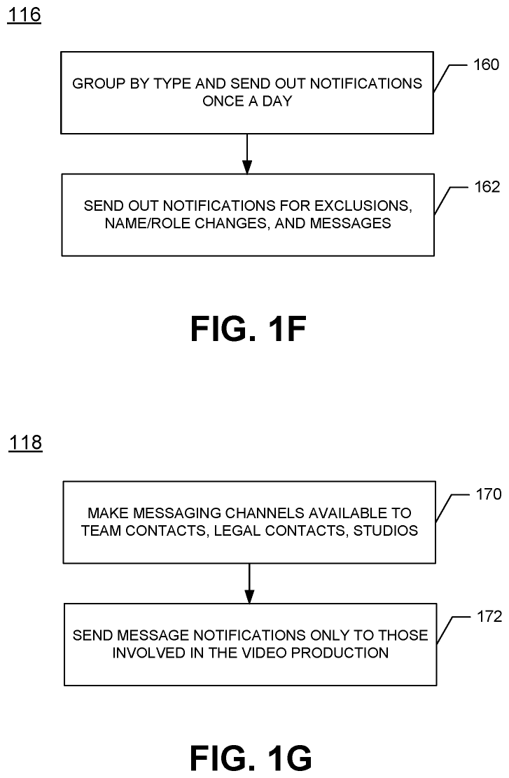

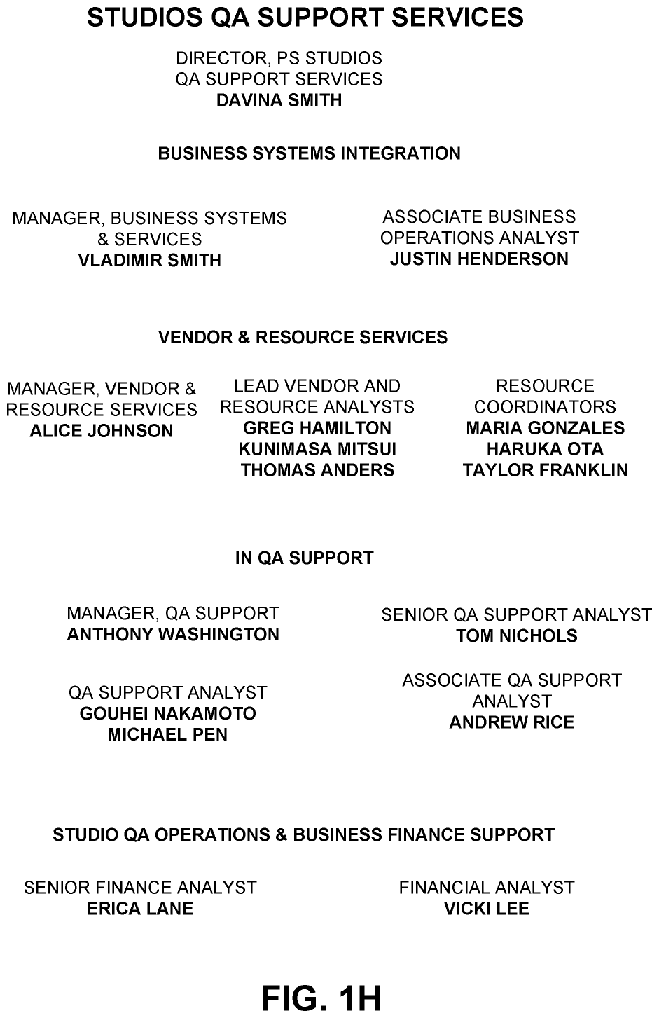

FIG. 1A is a flow diagram of a credit management process 100 to bring all aspects of credit gathering into a single application in accordance with one implementation of the present disclosure. In the illustrated implementation of FIG. 1A, users are enabled, at step 102, to submit and edit credit entries confidentially with an end-to-end service and under a permissions structure. In one implementation, the users use templated credits, at step 110, for quick submissions. Ordering and editing features of the credit management application are then used, at step 112, for submissions and edits. Open and lock titles feature is added, at step 114, to the credit management application to manage a timeline and structure of submitting and editing credits. A notification engine is then setup, at step 116, to provide to the users, including teams and individuals, visibility of changes and exclusions to the credit entries. Further, communication channels with centralized and trackable messaging are provided, at step 118.

In one implementation, the end-to-end service 102 is further illustrated in detail in FIG. 1B. Initially, team and/or department templates are provided, at step 120, to keep information up-to-date and easy to access. In one implementation, the templates include multiple points of contact for each team, department, and title. Credit submissions for a title are then started, at step 122. In one implementation, the credit submissions and adjustments include submissions for standard person and/or non-person credits. In one implementation, the non-person credits include credits for music licenses, fonts, and middleware. The submitted credits are managed and reordered, at step 124, with a studio view of the credits in the application. The submitted credits may be finalized and exported in one or more different formats, at step 126. In one implementation, the end-to-end service 102 also provides title changes and legal information, at step 128.

In one implementation, using the templated credits 110 is further illustrated in detail in FIG. 1C. Templates are used, at step 130, to quickly add, remove, or update individuals within each team, and descriptive categories are added, at step 132, to provide detailed information about teams and individuals. In one implementation, the detail information includes department descriptions, individual justifications, and contribution types.

In one implementation, using the ordering and editing features 112 of the credit management application is further illustrated in detail in FIG. 1D. A glance or expanded view of all teams is provided, at step 140, to view every individual credits. Names and roles are edited, at step 142, and individuals, teams, and departments are reordered, at step 144, using drag and drop features. The individuals who did not meet the requirements of the title are excluded, at step 146. In one implementation, excluded people are easily added back in if the decision to remove them is later changed. Further, additional teams/people and/or non-person credits for music licenses, fonts, middleware are added, at step 148.

In one implementation, providing title open and lock feature 114 of the credit management application is further illustrated in detail in FIG. 1E. At step 150, submissions are opened for teams to submit credits while a title is unlocked. Once the team submissions are determined to be done, at step 152, the credits are then ready to be edited, at step 154, by studios while a title is locked. In one implementation, team submissions after a title is locked is considered submission outside of the studio's timeline. Thus, credits submitted after the title has been locked must be approved, at step 156, before being included in a new list.

In one implementation, setting up the notification engine 116 is further illustrated in detail in FIG. 1F. Initially, both in-tool and email notifications are grouped by type and sent out once a day by default, at step 160. Then, at step 162, notifications for exclusions, name/role changes, and messages are sent out, at step 162.

In one implementation, providing communication channels 118 is further illustrated in detail in FIG. 1G. Initially, messaging channels are made available to team contacts, legal contacts, and studios, at step 170. Further, message notifications are only sent to those involved (e.g., involved in game, title, metaverse creations, etc.), at step 172. In one implementation, the notifications are sent out to the points of contact in charge of the team(s) affected by changes.

FIG. 1H is sample in-game credits, which may be generated by the credit management process 100 described above.

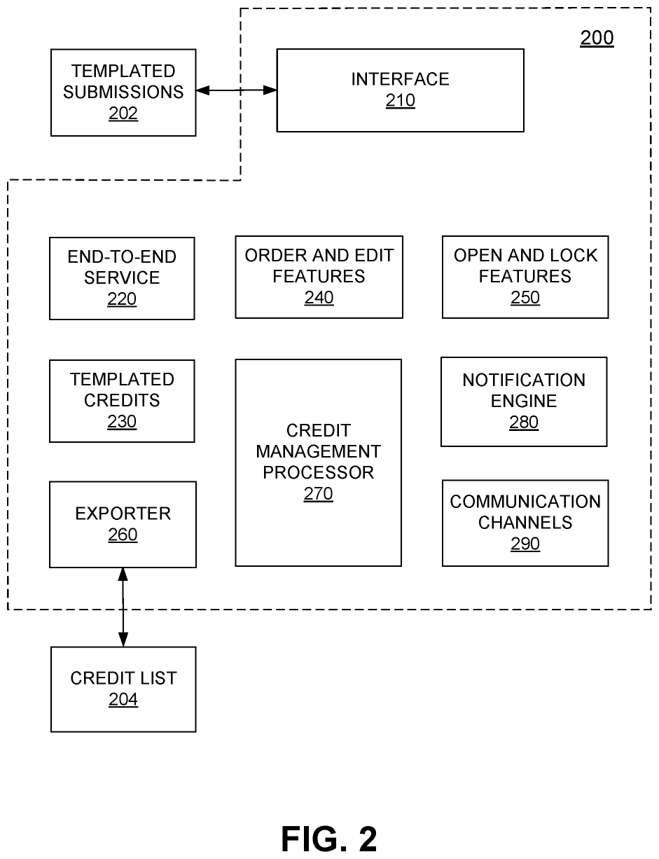

FIG. 2 is a block diagram of a credit management system 200 to bring all aspects of credit gathering into a single application in accordance with one implementation of the present disclosure. In the illustrated implementation of FIG. 2, the system 200 includes an interface 210, an end-to-end service unit 220, a templated credits unit 230, an order and edit features unit 240, an open and lock features unit 250, an exporter 260, a credit management processor 270, a notification engine 280, and a communication channels unit 290. In one implementation, blocks 210 through 290 of the system 200 are configured entirely with hardware including one or more digital signal processors (DSPs), general purpose microprocessors, application specific integrated circuits (ASICs), field programmable logic arrays (FPGAs), or other equivalent integrated or discrete logic circuitry.

In one implementation, the end-to-end service unit 220 receives the templated credit submissions 202 through the interface 210 and manages the submission 202 using the credit management processor 270. Thus, the end-to-end service unit 220 may be used to manage templated credit submissions from teams and/or departments to keep information up-to-date and easy to access. In one implementation, the templates include multiple points of contact for each team, department, and title. In one implementation, the credit submissions and adjustments include submissions for standard person and/or non-person credits including credits for music licenses, fonts, and middleware. In another implementation, the end-to-end service unit 220 manages and reorders the submitted credits with a studio view of the credits in the application. The end-to-end service unit 220 may also finalize and export submitted credits in one or more different formats using the exporter 260. In one implementation, the end-to-end service 220 also provides title changes and legal information.

In one implementation, the templated credits unit 230 uses templates to quickly add, remove, or update individuals within each team, and adds descriptive categories to provide detailed information about teams and individuals. In one implementation, the detail information includes department descriptions, individual justifications, and contribution types.

In one implementation, the order and edit features unit 240 provides a glance or expanded view of all teams to view every individual credits. The unit 240 then edits names and roles and reorders individuals, teams, and departments using drag and drop features. The unit 240 also excludes individuals who did not meet the requirements of the title. In one implementation, excluded people are easily added back in if the decision to remove them is later changed. The unit 240 further adds additional teams/people and/or non-person credits for music licenses, fonts, middleware.

In one implementation, the open and lock feature unit 250 opens submissions for teams to submit credits while a title is unlocked. The unit 250 enables studios to edit the credits, while the title is locked, once the team submissions are determined to be done. In one implementation, team submissions after a title is locked is considered submission outside of the studio's timeline. Thus, credits submitted after the title has been locked must be approved before being included in a new list.

In one implementation, the notification engine 280 is set up to group and send out both in-tool and email notifications once a day by default. The engine 280 also sends out notifications for exclusions, name/role changes, and messages.

In one implementation, the communication channels unit 290 makes messaging channels available to team contacts, legal contacts, and studios. The unit 290 sends out message notifications only to those involved in the video production.

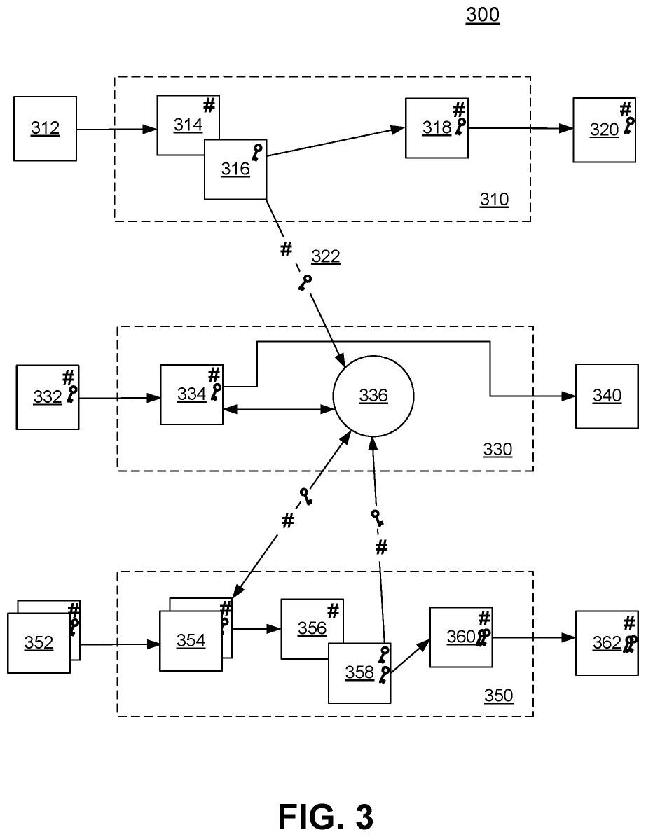

FIG. 3 is an integrated flow and block diagram of a metaverse content management process 300 to track user-generated digital content and all modifications to that content made by multiple users across the metaverse in accordance with one implementation of the present disclosure. In the illustrated implementation of FIG. 3, the process 300 is divided into three parts, digital content creation 310, content verification 330, and content modifications and updates 350.

In digital content creation 310, an individual piece of digital content 312 (created by a user) is assigned metadata which is used to track who created it (i.e., content/credit management). In one implementation, a unique hash 314 is generated to identify this individual content, and a cryptographic key 316 is then used to sign the unique hash to validate the authenticity of the hash 314. The content with the assigned metadata 318 is then returned to the user. This returned digital content 320 with the signed metadata attached and tracked is then made publicly available for other users to purchase and/or modify. All the metadata 322 for every piece of digital content is stored in the datastore 336. This datastore 336 holds all the hash and key data to track and verify all digital content and ownership.

In content verification 330, when the user views the digital content 332, the unique hash of that content is checked, at block 334, against the existing datastore 336 to verify that it is what it claims to be (i.e., content/credit management). The digital content is verified and then the metadata and ownership information are returned, at block 340, to the user.

In content modifications and updates 350, when an existing, tracked piece of digital content 352 is modified either by the original user or a new user, the original metadata remains attached to it. This content is checked against the submitted content/hash as well as the datastore and a discrepancy is flagged, at block 354. Another unique hash is generated, the old hash is resigned, at block 356, and a new cryptographic key is created, at block 358. This new key is associated with the existing assignment/ownership chain which provides a complete history of the content and any modifications. The content with the new assigned metadata is then returned to the user, at block 360. This digital content 362 with the new signed metadata attached and tracked is then made publicly available for other users to purchase and/or modify.

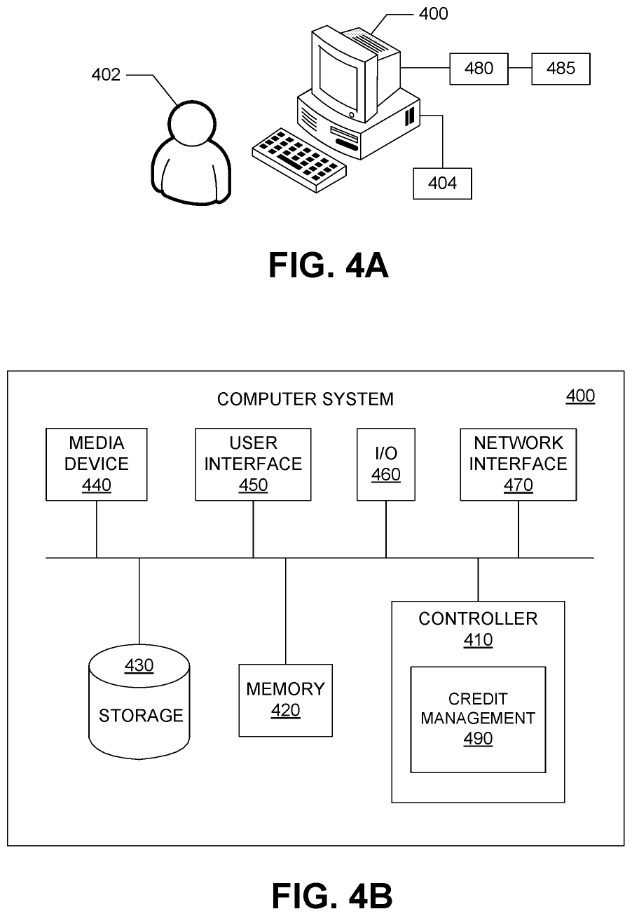

FIG. 4A is a representation of a computer system 400 and a user 402 in accordance with an implementation of the present disclosure. The user 402 uses the computer system 400 to implement a credit management application 490 as illustrated and described with respect to the method 100 and the system 200 in FIG. 1A and FIG. 2. In one implementation, the computer system 400 includes one of game console, gaming computer, or other electronic device that outputs a video signal to display a video game, movie, music video, or TV show.

The computer system 400 stores and executes the credit management application 490 of FIG. 4B. In addition, the computer system 400 may be in communication with a software program 404. Software program 404 may include the software code for the credit management application 490. Software program 404 may be loaded on an external medium such as a CD, DVD, or a storage drive, as will be explained further below.

Furthermore, computer system 400 may be connected to a network 480. The network 480 can be connected in various different architectures, for example, client-server architecture, a Peer-to-Peer network architecture, or other type of architectures. For example, network 480 can be in communication with a server 485 that coordinates engines and data used within the credit management application 490. Also, the network can be different types of networks. For example, the network 480 can be the Internet, a Local Area Network or any variations of Local Area Network, a Wide Area Network, a Metropolitan Area Network, an Intranet or Extranet, or a wireless network.

FIG. 4B is a functional block diagram illustrating the computer system 400 hosting the credit management application 490 in accordance with an implementation of the present disclosure. A controller 410 is a programmable processor and controls the operation of the computer system 400 and its components. The controller 410 loads instructions (e.g., in the form of a computer program) from the memory 420 or an embedded controller memory (not shown) and executes these instructions to control the system. In its execution, the controller 410 provides the credit management application 490 with a software system. Alternatively, this service can be implemented as separate hardware components in the controller 410 or the computer system 400.

Memory 420 stores data temporarily for use by the other components of the computer system 400. In one implementation, memory 420 is implemented as RAM. In one implementation, memory 420 also includes long-term or permanent memory, such as flash memory and/or ROM.

Storage 430 stores data either temporarily or for long periods of time for use by the other components of the computer system 400. For example, storage 430 stores data used by the credit management application 490. In one implementation, storage 430 is a hard disk drive.

The media device 440 receives removable media and reads and/or writes data to the inserted media. In one implementation, for example, the media device 440 is an optical disc drive.

The user interface 450 includes components for accepting user input from the user of the computer system 400 and presenting information to the user 402. In one implementation, the user interface 450 includes a keyboard, a mouse, audio speakers, and a display. The controller 410 uses input from the user 402 to adjust the operation of the computer system 400.

The I/O interface 460 includes one or more I/O ports to connect to corresponding I/O devices, such as external storage or supplemental devices (e.g., a printer or a PDA). In one implementation, the ports of the I/O interface 460 include ports such as: USB ports, PCMCIA ports, serial ports, and/or parallel ports. In another implementation, the I/O interface 460 includes a wireless interface for communication with external devices wirelessly.

The network interface 470 includes a wired and/or wireless network connection, such as an RJ-45 or “Wi-Fi” interface (including, but not limited to 802.11) supporting an Ethernet connection.

The computer system 400 includes additional hardware and software typical of computer systems (e.g., power, cooling, operating system), though these components are not specifically shown in FIG. 4B for simplicity. In other implementations, different configurations of the computer system can be used (e.g., different bus or storage configurations or a multi-processor configuration).

In one particular implementation, a method for bringing all aspects of credit gathering into a single application is disclosed. The method includes (1) receiving credit entries submitted by users and enabling the users to edit the credit entries confidentially with an end-to-end service and under a permissions structure, wherein the credit entries are received as templates, wherein the end-to-end service includes ordering and editing features. The method also includes (2) adding an open and lock titles feature to manage a timeline and structure of submitting and editing credits for a title. The method further includes (3) setting up a notification engine to provide the users with visibility of changes and exclusions to the credit entries.

In one implementation, the templates include multiple points of contact for each team, department, and the title. In one implementation, the credit entries include entries for at least one of standard person and non-person credits. In one implementation, the non-person credits include credits for music licenses, fonts, and middleware. In one implementation, the method further includes finalizing and exporting credits in one or more different formats. In one implementation, the method further includes adding descriptive categories to provide detailed information about teams and individuals. In one implementation, the detail information includes department descriptions, individual justifications, and contribution types. In one implementation, enabling the users to edit the credit entries includes enabling the users to edit names and roles and reordering individuals, teams, and departments using drag and drop features. In one implementation, the method further includes excluding individuals who did not meet requirements of the title. In one implementation, the open and lock titles feature includes opening for teams to submit the credits while the title is unlocked. In one implementation, the open and lock titles feature includes opening for studios to edit the credits while the title is locked. In one implementation, setting up the notification engine includes grouping in-tool and email notifications by type and sending out the notifications. In one implementation, the method further includes providing communication channels with centralized and trackable messaging. In one implementation, the messaging communication channels are made available to team contacts, legal contacts, and studios.

In another particular implementation, a credit management system to gather and manage credit submissions for a title in templates includes an interface, an end-to-end service, a templated credits unit, and an order and edit features unit. The interface receives the credit submissions from teams and departments. The end-to-end service to manage the received credit submissions in the templates, wherein the templates include multiple points of contact for each team, department, and title. The templated credits unit enables a user to add, remove, or update individuals within each team, and add descriptive categories to provide detailed information about teams and individuals. The order and edit features unit to provide an expanded view of all teams to view individual credits, wherein the order and edit features unit enables the user to edit names and roles and reorder individuals, teams, and departments using drag and drop features, and wherein the order and edit features unit also enables the user to exclude individuals who did not meet requirements of the title. The open and lock feature unit to open submissions for the teams to submit credits while a title is unlocked, and for studios to edit the credits while the title is locked.

In one implementation, the system further includes a notification engine to provide the user with visibility of changes and exclusions to the submitted credits. In one implementation, the notification engine sends out email notifications of the submitted credits, exclusions, name or role changes, and messages. In one implementation, the system further includes a communication channels unit to make messaging channels available to team contacts, legal contacts, and studios.

In yet another particular implementation, method for tracking digital content and modifications to that content made by multiple users across metaverse is disclosed. The method includes assigning metadata to the digital content, wherein the metadata is used to track who created the digital content, and wherein the metadata includes a hash generated to identify the digital content and a cryptographic key used to sign the unique hash to validate the authenticity of the hash. The method also includes storing the metadata in datastore to hold the hash and the cryptographic key to track and verify the digital content and an ownership of the digital content.

In one implementation, the method further includes checking the hash of the digital content against the hash stored in the datastore to validate the authenticity of the hash. In one implementation, the method further includes tracking the digital content to determine whether the digital content has been modified, generating new metadata including new hash and key for the digital content when the tracked digital content is determined to have been modified, and attaching the generated new metadata to the digital content.

The descriptions herein of the disclosed implementations are provided to enable any person skilled in the art to make or use the present disclosure. Numerous modifications to these implementations would be readily apparent to those skilled in the art, and the principles defined herein can be applied to other implementations without departing from the spirit or scope of the present disclosure. For example, following additional features may be included in the credit management application: (1) legal checklists to quickly add common legal lines; (2) Logo handling for middleware; (3) full-change history audit; (4) mass editing for template data; (5) approval chain system; (6) duplicate entry automated check; (7) automatic validation of names against HR systems (shared services); (8) adding third-party vendor credits; (9) submission status alerts of teams that have not yet submitted to a title; and (10) credits milestones and timelines to show the full process of a title at a glance.

In one implementation, (1) the legal checklist is used as middleware/software to be quickly checked off a list and included rather than typing each out individually in the non-person credits field; (2) logo handling is a process for including an image file to meet the requirements of using a particular middleware in a product; (3) full change history audit is a list of all changes made to a product (automatically created when any changes are made), which show who made changes and when the changes were made; (4) mass editing for template data is a feature that allows a user to make a change to multiple entries at the same time (e.g., change multiple credits to/from the Direct contribution status to the Support contribution status, or change multiple credits from Tester to Senior Tester); (5) approval chain system is a feature to make sure that credits submitted to a product must be approved by another user or set of users before being submitted; (6) duplicate entry automated check is an automated check within the submitted credits to see if any individual was already submitted on any other team; (7) automatic validation is another automated check to see if a submitted name matches the records in a company's HR records, which would check both name and role to see if it matches a record in the HR system; (8) third Party vendor credits would be the same process as any other credits, but may include additional security measures since they are not full-time employees; (9) submission status alerts are automatic notifications sent out to the points of contact for groups that have not submitted yet to a product to make sure that they have not forgotten to do so; and (10) credits milestones are customizable timelines for each product to show how far along a product is in production (e.g., alpha/beta release, credits initiation, credits lock, etc.). Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for bringing all aspects of credit gathering into a single application, the method comprising:
receiving credit entries submitted by users and enabling the users to edit the credit entries confidentially with an end-to-end service and under a permissions structure,
wherein the credit entries are received as templates,
wherein the end-to-end service includes ordering and editing features;
adding an open and lock titles feature to manage a timeline and structure of submitting and editing credits for a title; and
setting up a notification engine to provide the users with visibility of changes and exclusions to the credit entries.

2. The method of claim 1, wherein the templates comprise multiple points of contact for each team, department, and the title.

3. The method of claim 1, wherein the credit entries comprise entries for at least one of standard person and non-person credits.

4. The method of claim 3, wherein the non-person credits comprise credits for music licenses, fonts, and middleware.

5. The method of claim 1, further comprising finalizing and exporting credits in one or more different formats.

6. The method of claim 1, further comprising adding descriptive categories to provide detailed information about teams and individuals.

7. The method of claim 6, wherein the detail information comprises department descriptions, individual justifications, and contribution types.

8. The method of claim 1, wherein enabling the users to edit the credit entries comprises enabling the users to edit names and roles and reordering individuals, teams, and departments using drag and drop features.

9. The method of claim 1, further comprising
excluding individuals who did not meet requirements of the title.

10. The method of claim 1, wherein the open and lock titles feature comprises opening for teams to submit the credits while the title is unlocked.

11. The method of claim 1, wherein the open and lock titles feature comprises opening for studios to edit the credits while the title is locked.

12. The method of claim 1, wherein setting up the notification engine comprises grouping in-tool and email notifications by type and sending out the notifications.

13. The method of claim 1, further comprising providing communication channels with centralized and trackable messaging.

14. The method of claim 13, wherein the messaging communication channels are made available to team contacts, legal contacts, and studios.

15. A credit management system to gather and manage credit submissions for a title in templates, the system comprising:
an interface to receive the credit submissions from teams and departments;
an end-to-end service to manage the received credit submissions in the templates,
wherein the templates include multiple points of contact for each team, department, and title;
a templated credits unit to enable a user to add, remove, or update individuals within each team, and add descriptive categories to provide detailed information about teams and individuals;
an order and edit features unit to provide an expanded view of all teams to view individual credits,
wherein the order and edit features unit enables the user to edit names and roles and reorder individuals, teams, and departments using drag and drop features,
wherein the order and edit features unit also enables the user to exclude individuals who did not meet requirements of the title; and
an open and lock feature unit to open submissions for the teams to submit credits while a title is unlocked, and for studios to edit the credits while the title is locked.

16. The system of claim 15, further comprising
a notification engine to provide the user with visibility of changes and exclusions to the submitted credits.

17. The system of claim 16, wherein the notification engine sends out email notifications of the submitted credits, exclusions, name or role changes, and messages.

18. The system of claim 15, further comprising
a communication channels unit to make messaging channels available to team contacts, legal contacts, and studios.

19. A method for tracking digital content and modifications to that content made by multiple users across metaverse, the method comprising:
assigning metadata to the digital content,
wherein the metadata is used to track who created the digital content,
wherein the metadata includes a hash generated to identify the digital content and a cryptographic key used to sign the unique hash to validate the authenticity of the hash; and
storing the metadata in datastore to hold the hash and the cryptographic key to track and verify the digital content and an ownership of the digital content.

20. The method of claim 19, further comprising
checking the hash of the digital content against the hash stored in the datastore to validate the authenticity of the hash.

21. The method of claim 19, further comprising:
tracking the digital content to determine whether the digital content has been modified;
generating new metadata including new hash and key for the digital content when the tracked digital content is determined to have been modified; and
attaching the generated new metadata to the digital content.
